(19) United States
(12) Patent Application Publication
(10) Pub. No.: US 2010/0243384 A1
(43) Pub. Date: Sep. 30, 2010

(54) DISC BRAKE APPARATUS

(75) Inventors: Shinichi Morita, Nagoya-shi (JP); Satoru Itsuaki, Nagoya-shi (JP)

Correspondence Address: BUCHANAN, INGERSOLL & ROONEY PC, POST OFFICE BOX 1404, ALEXANDRIA, VA, 22313-1404, US

(73) Assignee: ADVICS CO., LTD., Kariiya-city (JP)

(21) Appl. No.: 12/732,873

(22) Filed: Mar. 26, 2010

(30) Foreign Application Priority Data
Mar. 31, 2009 (JP) 2009-85282

(51) Int. Cl. F16D 65/16

(52) U.S. Cl. 188/73.1

(57) ABSTRACT

The present invention is to stabilize behavior of brake pads at the time of braking of a disc brake so as to suppress generation of brake noise, and also to reduce the roll moment of the brake pads generated at the time of braking so as to suppress uneven abrasion of linings. A back plate (41) of a brake pad (40) is biased inward in the rotor radial direction by a plate spring (80). The back plate (41) is engaged at two points with an inner periphery support shaft (61) provided integrally with a caliper (20) on a V-shape inner peripheral abutment (41a) (provided in the back plate (41) on the inner side of a lining (42) in the rotor radial direction and on the center in the rotor circumferential direction), and engaged at one point with an outer periphery support shaft (62) provided integrally with the caliper (20) on an outer peripheral abutment (41b) (provided in the back plate (41) on the outer side of the lining (42) in the rotor radial direction and on the center in the rotor circumferential direction).

### BACKGROUND OF THE INVENTION

1. Field of the Invention

The present invention relates to a disc brake apparatus, particularly a disc brake apparatus provided with a disc rotor connected to a rotating member (such as an axle hub) and rotated integrally with the rotating member, a caliper connected to a support member (such as a vehicle body) so as to be astride a part of an outer periphery of this disc rotor, a pair of brake pads arranged so as to grip the disc rotor and supported on the caliper by support shafts movably in the rotor axial direction, and pistons connected to the caliper for pressing the brake pads toward the disc rotor, the pistons being adapted to press back plates of the brake pads so that linings of the brake pads are slidably forced against brake surfaces of the disc rotor for braking the disc rotor.

2. Description of Related Art

This type of disc brake apparatus is described in National Patent Publication No. 2008-527272 (will be referred to as Patent Literature 1) described below, for example. In the disc brake apparatus, brake pads are respectively supported on a caliper movably in the rotor axial direction by a single pair of inner periphery support shafts provided integrally with the caliper and respectively engaged with inner peripheral engagement surfaces provided in back plates on the inner side of linings in the rotor radial direction and on the center in the rotor circumferential direction, and a single pair of outer periphery support shafts provided integrally with the caliper passing through through-holes provided in arm portions of the back plates extending outward in the rotor radial direction on one side (the leading side) of the linings, and supported on the caliper movably in the rotor axial direction at an abutment (a flat surface) formed in the caliper and engaged with end surfaces (flat surfaces) formed in the back plates on the other side (the trailing side) of the linings.

In the disc brake apparatus described in Patent Literature 1, a point where torque at the time of braking is received is mainly the abutment (the flat surface) formed in the caliper and engaged with the end surfaces (the flat surfaces) formed in ends of the back plates in the rotor circumferential direction on the other side of the linings. The abutment (the flat surface) is an unstable flat surface which is easily changed due to an engagement relationship between the inner peripheral engagement surfaces of the back plates and the inner periphery support shafts (manufacturing errors of the members, connection errors or deformation caused by thermal expansion) or the like, and which is not easily engaged with the end surfaces (the flat surfaces) of the back plates while being flush with the end surfaces. Therefore, there is a fear that behavior of the brake pads may be unstable at the time of braking and hence brake noise may be generated. In this case, there is a need for processing work for forming the abutment (the flat surface) in the caliper and also processing work on the entire end surfaces (the flat surfaces) of the back plates on the other side. Thus, an area requiring the processing work is large and hence the cost is increased.

In the disc brake apparatus described in Patent Literature 1, the point where the torque at the time of braking is received is the abutment (the flat surface) engaged with the end surfaces of the back plates on the other side (the trailing side of the linings) which is largely away from the back plates on the one side (the leading side of the linings) (that is, the moment arm is long). Therefore, the roll moment of the brake pads generated at the time of braking is large (the roll moment is generated due to displacement of sliding surfaces between the disc rotor and the linings in the rotor axial direction relative to the point where the torque at the time of braking is received, which is the rotation moment for increasing surface pressure of the linings on the leading side in comparison to surface pressure thereof on the trailing side). Thus, surface pressure distribution of the linings relative to the disc rotor is insufficient, and uneven abrasion of the linings in the rotor circumferential direction is unavoidable.

### SUMMARY OF THE INVENTION

The present invention is achieved in order to solve the above-mentioned problems. According to the present invention, a disc brake apparatus is provided including a disc rotor connected to a rotating member and rotated integrally with the rotating member, a caliper connected to a support member so as to be astride a part of an outer periphery of the disc rotor, a pair of brake pads arranged so as to grip the disc rotor and supported on the caliper movably in the rotor axial direction by support shafts, and pistons connected to the caliper for pressing the brake pads toward the disc rotor, the pistons pressing back plates of the brake pads so that linings of the brake pads are slidably forced against brake surfaces of the disc rotor for braking the disc rotor, in which the brake pads are biased inward in the rotor radial direction by a bias member, and the support shafts include a single pair of inner periphery support shafts provided integrally with the caliper and respectively engaged at two points with V-shape inner peripheral abutments provided in the back plates on the inner side of the linings in the rotor radial direction and on the center in the rotor circumferential direction, and outer periphery support shafts provided integrally with the caliper and respectively engaged at one point with outer peripheral abutments provided in the back plates on the outer side of the linings in the rotor radial direction and on the middle in the rotor circumferential direction.

In this case, a single pair of the outer periphery support shafts and a single pair of the outer peripheral abutments may be respectively arranged on the center of the linings in the rotor circumferential direction. Two pairs of the outer periphery support shafts and two pairs of the outer peripheral abutments may be respectively arranged at a predetermined interval in the rotor circumferential direction across the center of the linings in the rotor circumferential direction. The bias member is placed between the outer periphery support shafts and the back plates or between the caliper and the back plates.

In the disc brake apparatus according to the present invention, at the time of braking the disc rotor, torque at the time of braking is receivable at three points in total including two engagement points between the V-shape inner peripheral abutments of the brake pads and the inner periphery support shafts, and one engagement point between the outer peripheral abutments of the brake pads and the outer periphery support shafts. Therefore, behavior of the brake pads is stabilized in comparison to a case where the torque at the time of braking is received on an unstable flat surface (for example, in a case of the disc brake apparatus described in Patent Literature 1). Thus, it is possible to suppress generation of brake noise in accordance with unstable behavior at the time of braking. Areas (processing areas) of the points where the torque at the time of braking is received are reduced in comparison to a case where the torque at the time of braking is received on an unstable flat surface. Thus, it is possible to reduce processing cost.

In the disc brake apparatus according to the present invention, the points where the torque at the time of braking is received include the positions on the inner side of the linings in the rotor radial direction and on the center in the rotor circumferential direction, and also the positions on the outer side of the linings in the rotor radial direction and on the middle in the rotor circumferential direction. These positions are not largely away from end surfaces of the linings in the rotor circumferential direction (the moment arm is short). Thus, it is possible to reduce the roll moment of the brake pads generated at the time of braking in comparison to the disc brake apparatus described in Patent Literature 1, and also to obtain uniform surface pressure distribution of the linings relative to the disc rotor so as to suppress uneven abrasion of the linings in the rotor circumferential direction.

In the present invention, the bias member may have the bias force set so that leading parts of the brake pads are on the outer side of trailing parts of the brake pads in the rotor radial direction. In this case, the three points where the torque at the time of braking is received are in an already engaged (abutted) state by the bias force of the bias member before braking. Thus, it is possible to suppress a chattering of the brake pads on the support shafts connected to the caliper at the time of non-braking of the disc rotor. At the time of braking, the back plates of the brake pads are not abutted with the outer periphery support shafts. Thus, it is possible to suppress (eliminate) generation of a clonk (an impact sound generated by abutment of the back plates with the outer periphery support shafts).

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a front view showing a first embodiment of a disc brake apparatus according to the present invention;

FIG. 2 is a right side view of the disc brake apparatus shown in FIG. 1;

FIG. 3 is a sectional view along the line A-A in FIG. 2;

FIG. 4 is a sectional view along the line B-B in FIG. 2;

FIG. 5 is a sectional view along the line C-C in FIG. 1;

FIG. 6 is a sectional view along the line D-D in FIG. 1;

FIG. 7 is a front view showing a second embodiment of a disc brake apparatus according to the present invention;

FIG. 8 is a back view of the disc brake apparatus shown in FIG. 7;

FIG. 9 is a sectional view of the disc brake apparatus shown in FIG. 7 corresponding to FIG. 3; and

FIG. 10 is a sectional view of the disc brake apparatus shown in FIG. 7 corresponding to FIG. 4.

### DETAILED DESCRIPTION OF THE PREFERRED EMBODIMENTS

Hereinafter, embodiments of the present invention will be described based on the drawings.

### First Embodiment

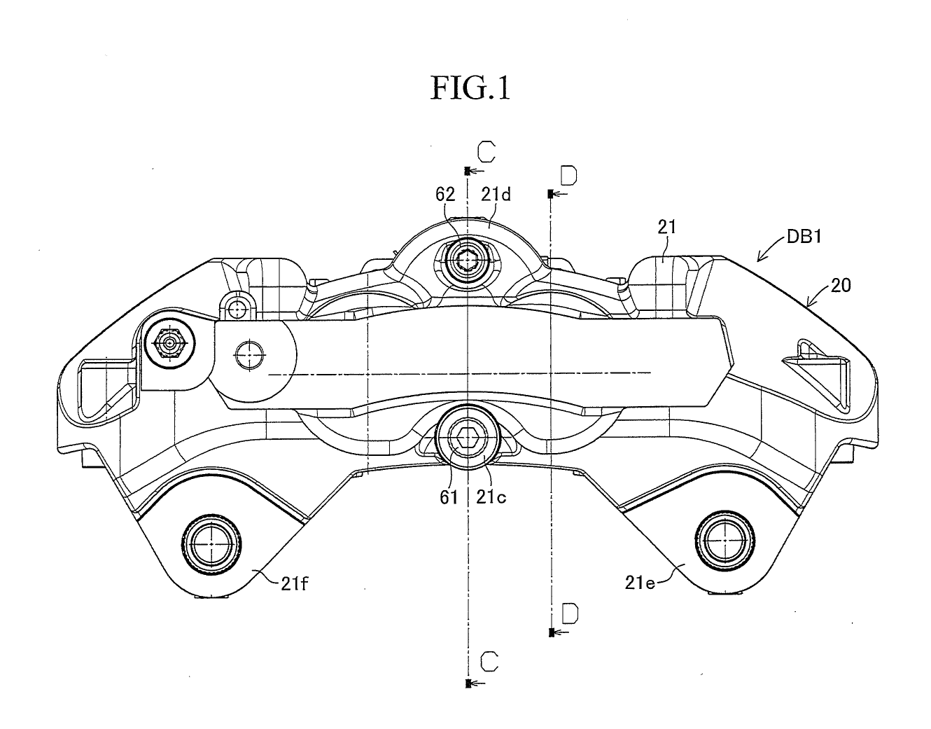

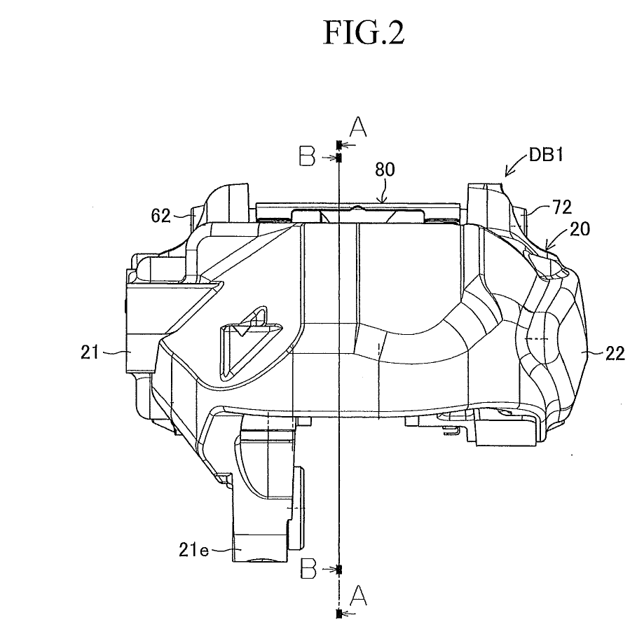

FIGS. 1 to 6 show a first embodiment in which a disc brake apparatus of the present invention is utilized as an opposed piston type (fixed type) disc brake apparatus for a vehicle. A disc brake apparatus DB1 according to the first embodiment is provided with a disc rotor 10 connected to an axle hub (a rotating member not shown in the figures) and rotated integrally with a wheel (not shown), a caliper 20 arranged so as to be astride a part of an outer peripheral portion of this disc rotor 10, four pistons 31, 32, 33, 34 connected to this caliper 20, an inner-side brake pad 40, and an outer-side brake pad 50. The disc brake apparatus DB1 is also provided with, in the caliper 20, an inner-side inner periphery support shaft 61, an inner-side outer periphery support shaft 62, an outer-side inner periphery support shaft 71, an outer-side outer periphery support shaft 72, and a plate spring 80.

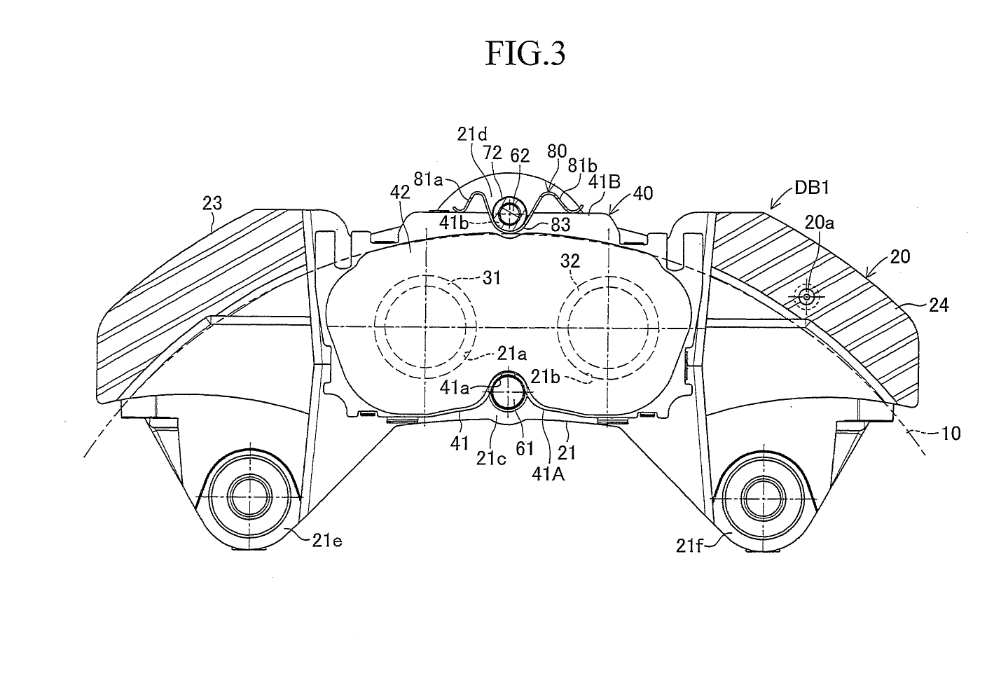

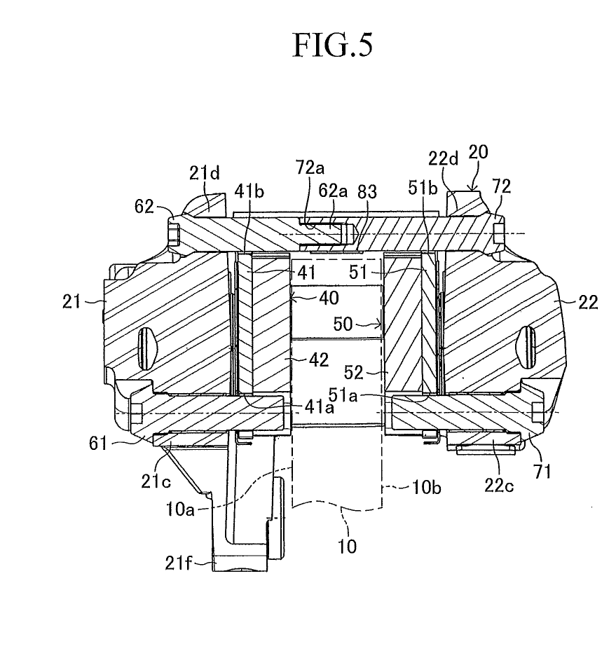

As shown in FIG. 5, the disc rotor 10 has circular brake surfaces 10a, 10b to be gripped by a lining 42 of the inner-side brake pad 40 and a lining 52 of the outer-side brake pad 50. Rotation of the disc rotor 10 is slowed down or stopped by gripping the brake surfaces 10a, 10b by the lining 42 of the inner-side brake pad 40 and the lining 52 of the outer-side brake pad 50 at the time of braking. This disc rotor 10 is rotated clockwise in FIG. 3 integrally with the wheel (forward rotation) when the wheel is rotated forward. Thus, the left side in FIG. 3 indicates the leading side and the right side in FIG. 3 indicates the trailing side.

As shown in FIGS. 1 to 6, the caliper 20 is provided with an inner housing portion 21 and an outer housing portion 22 facing each other so as to be astride a part of the outer peripheral portion of the disc rotor 10, and a pair of coupling portions 23, 24 for coupling these housing portions. The inner housing portion 21 is arranged on the inner side of the disc rotor 10 and has a pair of cylinders 21a, 21b (refer to FIG. 3).

The inner housing portion 21 has a support portion 21c for supporting the inner-side inner periphery support shaft 61 to be engaged with a V-shape inner peripheral abutment 41a provided in a back plate 41 of the inner-side brake pad 40 on the inner side in the rotor radial direction and on the center in the rotor circumferential direction, and also has a support portion 21d for supporting the inner-side outer periphery support shaft 62 engageable with a V-shape outer peripheral abutment 41b provided in the back plate 41 of the inner-side brake pad 40 on the outer side in the rotor radial direction and on the center in the rotor circumferential direction.

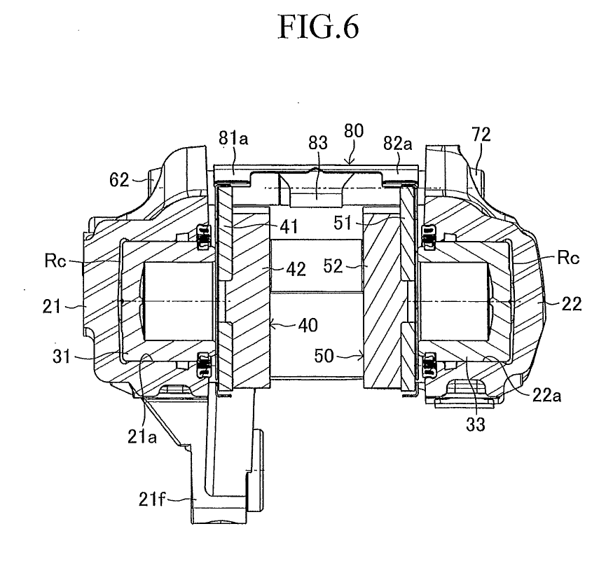

The inner housing portion 21 has a pair of attachment portions 21e, 21f extending inward in the rotor radial direction at ends thereof on the inner side in the rotor radial direction. The inner housing portion 21 is attached to a vehicle body (a support member) at these attachment portions 21e, 21f with using bolts (not shown). A pair of the cylinders 21a, 21b is arranged at a predetermined interval in the rotor circumferential direction as shown in FIG. 3, and also formed in the rotor axial direction as shown in FIG. 6.

The outer housing portion 22 is arranged on the outer side of the disc rotor 10. The outer housing portion 22 has a pair of cylinders 22a, 22b as well as the cylinders 21a, 21b of the inner housing portion 21, and also has a support portion 22c for supporting the outer-side inner periphery support shaft 71 and a support portion 22d for supporting the outer-side outer periphery support shaft 72 as well as the support portions 21c, 21d of the inner housing portion 21.

As shown in FIGS. 3, 4 and 6, the pistons 31, 32, 33, 34 are connected to the cylinders 21a, 21b, 22a, 22b liquid-tightly and slidably in the rotor axial direction as well known in the art, and also arranged so as to face each other across the disc rotor 10. The pistons 31, 32, 33, 34 are pushed by working oil supplied from a brake master cylinder (not shown) to oil chambers Rc respectively formed between the pistons 31, 32, 33, 34 and the cylinders 21a, 21b, 22a, 22b at the time of braking the disc rotor 10 so as to press the inner-side brake pad 40 and the outer-side brake pad 50 toward the disc rotor 10 in the rotor axial direction. It should be noted that the oil chambers Rc communicate with each other through an oil passage 20a provided in the caliper 20.

As shown in FIGS. 3, 5 and 6, the inner-side brake pad 40 includes the back plate 41 and the lining 42 fixed to this back plate 41. As shown in FIGS. 3 and 5, the inner-side brake pad 40 is arranged on the side of the inner housing portion 21 of the caliper 20, and connected to the inner-side inner periphery support shaft 61 and the inner-side outer periphery support shaft 62 at the back plate 41.

As shown in FIGS. 3, 5 and 6, the back plate 41 formed into a flat plate has an inside portion 41A extending inward in the rotor radial direction relative to the lining 42 and forming the V-shape inner peripheral abutment 41a, and an outside portion 41B extending outward in the rotor radial direction relative to the lining 42 and forming the V-shape outer peripheral abutment 41b. The inner peripheral abutment 41a is provided on the inner side of the lining 42 in the rotor radial direction and on the center in the rotor circumferential direction. The outer peripheral abutment 41b is provided on the outer side of the lining 42 in the rotor radial direction and on the center in the rotor circumferential direction.

The lining 42 is formed into a substantially fan shape so as to extend in the rotor circumferential direction. When the pistons 31, 32 press the back plate 41, the lining 42 is slidably forced against the brake surface 10a of the disc rotor 10 for braking the disc rotor 10. It should be noted that at the time of slowing down or stopping forward rotation of the disc rotor 10 (at the time of braking the disc rotor while the vehicle travels forward), the friction force acts on the lining 42 slidably forced against the brake surface 10a of the disc rotor 10 from the leading side to the trailing side in the rotor circumferential direction.

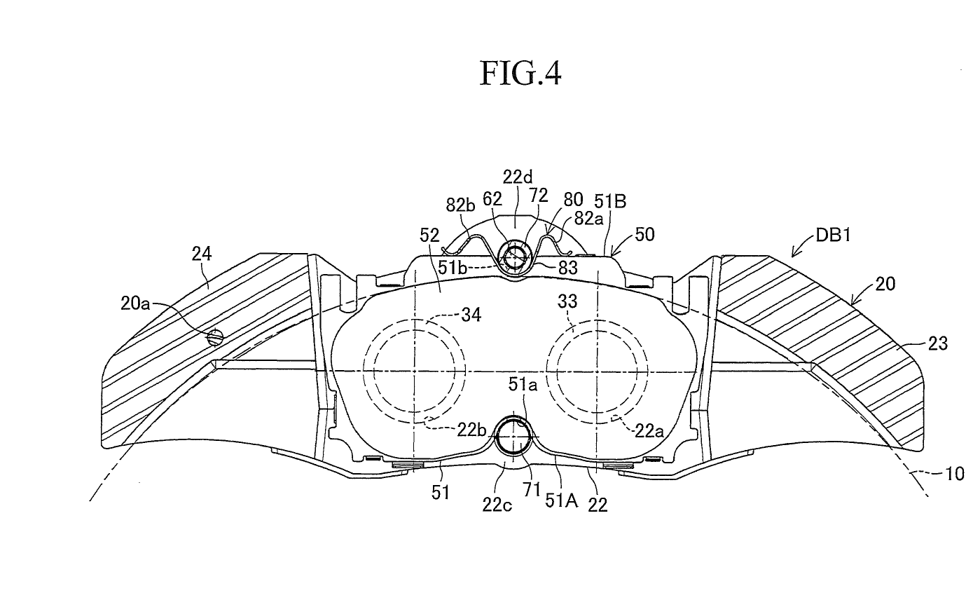

As shown in FIGS. 4, 5 and 6, the outer-side brake pad 50 includes a back plate 51, and the lining 52 fixed to this back plate 51. As shown in FIGS. 4 and 5, the outer-side brake pad 50 is arranged on the side of the outer housing portion 22 of the caliper 20, and connected to the outer-side outer periphery support shaft 71 and the outer-side outer periphery support shaft 72 at the back plate 51.

As shown in FIGS. 4, 5 and 6, the back plate 51 formed into a flat plate has an inside portion 51A extending inward in the rotor radial direction relative to the lining 52 and forming a V-shape inner peripheral abutment 51a, and an outside portion 51B extending outward in the rotor radial direction relative to the lining 52 and forming a V-shape outer peripheral abutment 51b. The inner peripheral abutment 51a is provided on the inner side of the lining 52 in the rotor radial direction and on the center in the rotor circumferential direction. The outer peripheral abutment 51b is provided on the outer side of the lining 52 in the rotor radial direction and on the center in the rotor circumferential direction.

The lining 52 is formed into a substantially fan shape so as to extend in the rotor circumferential direction. When the pistons 33, 34 press the back plate 51, the lining 52 is slidably forced against the brake surface 10b of the disc rotor 10 for braking the disc rotor 10. It should be noted that at the time of slowing down or stopping the forward rotation of the disc rotor 10 (at the time of braking the disc rotor while the vehicle travels forward), the friction force acts on the lining 52 slidably forced against the brake surface 10b of the disc rotor 10 from the leading side to the trailing side in the rotor circumferential direction.

As shown in FIG. 5, the inner-side inner periphery support shaft 61, the inner-side outer periphery support shaft 62, the outer-side inner periphery support shaft 71 and the outer-side outer periphery support shaft 72 are respectively screwed to the support portions 21c, 21d, 22c, 22d of the caliper 20 and extend in the rotor axial direction. The inner-side outer periphery support shaft 62 has a male screw portion 62a at a top end thereof which is screwed into and coupled to a female screw portion 72a provided at a top end of the outer-side outer periphery support shaft 72.

The plate spring 80 is placed between the inner-side outer periphery support shaft 62 and the outer-side outer periphery support shaft 72 integrally coupled to each other by screwing and the back plates 41, 51 for biasing the inner-side brake pad 40 and the outer-side brake pad 50 inward in the rotor radial direction. The plate spring 80 has a leading-side arm 81a and a trailing-side arm 81b to be engaged with the back plate 41 of the inner-side brake pad 40, and a leading-side arm 82a and a trailing-side arm 82b to be engaged with the back plate 51 of the outer-side brake pad 50. The plate spring 80 is connected to the inner-side outer periphery support shaft 62 and the outer-side outer periphery support shaft 72 at a coupling portion 83 for coupling the arms 81a, 81b, 82a, 82b. The leading-side arms 81a, 82a have smaller bias force than the bias force of the trailing-side arms 81b, 82b so that leading parts of the brake pads 40, 50 are on the outer side of trailing parts of the brake pads in the rotor radial direction.

Thereby, the back plate 41 of the inner-side brake pad 40 is engaged with the inner-side inner periphery support shaft 61 without any gap inbetween at two points of the inner peripheral abutment 41a including a position from one o'clock to two o'clock and a position from ten o'clock to eleven o'clock with regard to the inner-side inner periphery support shaft 61 in FIG. 3, and also engaged with the inner-side outer periphery support shaft 62 without any gap inbetween at one point of the outer peripheral abutment 41b which is a position from seven o'clock to eight o'clock with regard to the inner-side outer periphery support shaft 62 in FIG. 3.

Meanwhile, the back plate 51 of the outer-side brake pad 50 is engaged with the outer-side inner periphery support shaft 71 without any gap inbetween at two points of the inner peripheral abutment 51a including a position from one o'clock to two o'clock and a position from ten o'clock to eleven o'clock with regard to the outer-side inner periphery support shaft 71 in FIG. 4, and also engaged with the outer-side outer periphery support shaft 72 without any gap inbetween at one point of the outer peripheral abutment 51b which is a point from four o'clock to five o'clock with regard to the outer-side outer periphery support shaft 72 in FIG. 4.

With the arrangement of the first embodiment described above, when the working oil is supplied from the brake master cylinder (not shown) to the oil chambers Rc in accordance with depressing of a brake pedal (not shown), the pistons 31, 32, 33, 34 are pushed toward the disc rotor 10 so as to press the inner-side brake pad 40 and the outer-side brake pad 50 toward the disc rotor 10. Thereby, the linings 42, 52 of the inner-side brake pad 40 and the outer-side brake pad 50 are slidably forced against the brake surfaces 10a, 10b of the disc rotor 10 for braking the disc rotor 10. It should be noted that when the depressed brake pedal (not shown) is released and the working oil is discharged from the oil chambers Rc to the brake master cylinder (not shown), braking of the disc rotor 10 is cancelled.

With the arrangement of the first embodiment described above, at the time of braking the disc rotor 10 (at the time of slowing down or stopping the forward rotation of the disc rotor), the torque at the time of braking is received at three points in total including two engagement points between the V-shape inner peripheral abutments 41a, 51a of the brake pads 40, 50 and the inner periphery support shafts 61, 71, and one engagement point between the V-shape outer peripheral abutments 41b, 51b of the brake pads 40, 50 and the outer periphery support shafts 62, 72. Therefore, behavior of the brake pads 40, 50 is stabilized in comparison to a case where the torque at the time of braking is received on an unstable flat surface (for example, in a case of the disc brake apparatus described in Patent Literature 1). Thus, it is possible to suppress generation of brake noise in accordance with unstable behavior at the time of braking. Areas (processing areas) of the points where the torque at the time of braking is received are reduced in comparison to a case where the torque at the time of braking is received on an unstable flat surface. Thus, it is possible to reduce processing cost.

According to the first embodiment, the points where the torque at the time of braking is received include the positions on the inner side of the linings 42, 52 in the rotor radial direction and on the center in the rotor circumferential direction, and also the positions on the outer side of the linings 42, 52 in the rotor radial direction and on the center in the rotor circumferential direction. These positions are not largely away from end surfaces of the linings 42, 52 in the rotor circumferential direction (the moment arm is short). Thus, it is possible to reduce the roll moment of the brake pads 40, 50 generated at the time of braking in comparison to the disc brake apparatus described in Patent Literature 1, and also to obtain uniform surface pressure distribution of the linings 42, 52 relative to the disc rotor 10 so as to suppress uneven abrasion of the linings 42, 52 in the rotor circumferential direction.

According to the first embodiment, the plate spring 80 placed between the outer periphery support shafts 62, 72 and the back plates 41, 51 has the bias force set so that the leading parts of the brake pads 40, 50 are on the outer side of the trailing parts of the brake pads in the rotor radial direction. Therefore, the three points where the torque at the time of braking is received are in an already engaged (abutted) state by the bias force of the plate spring 80 before braking. Thus, it is possible to suppress a chattering of the brake pads 40, 50 on the support shafts 61, 62, 71, 72 connected to the caliper 20 at the time of non-braking of the disc rotor 10. For example, at the time of braking, the back plates 41, 51 of the brake pads 40, 50 are not abutted with the outer periphery support shafts 62, 72 unlike the initial stage of braking the disc rotor while the vehicle travels forward (at the time of slowing down or stopping the forward rotation of the disc rotor 10). Thus, it is possible to suppress (eliminate) generation of a clonk (an impact sound generated by abutment of the back plates 41, 51 with the outer periphery support shafts 62, 72).

It should be noted that at the time of slowing down or stopping reverse rotation of the disc rotor 10, the back plates 41, 51 of the brake pads 40, 50 are abutted with the outer periphery support shafts 62, 72 at the initial stage of braking, so that a clonk is generated. However, after the initial stage, it is possible to obtain the same operation as the operation at the time of slowing down or stopping the forward rotation of the disc rotor 10. Thus, even at the time of slowing down or stopping the reverse rotation of the disc rotor 10 (at the time of braking the disc rotor while the vehicle travels reversely), it is possible to obtain the same effect as the effect obtained at the time of slowing down or stopping the forward rotation of the disc rotor 10 (at the time of braking the disc rotor while the vehicle travels forward).

### Second Embodiment

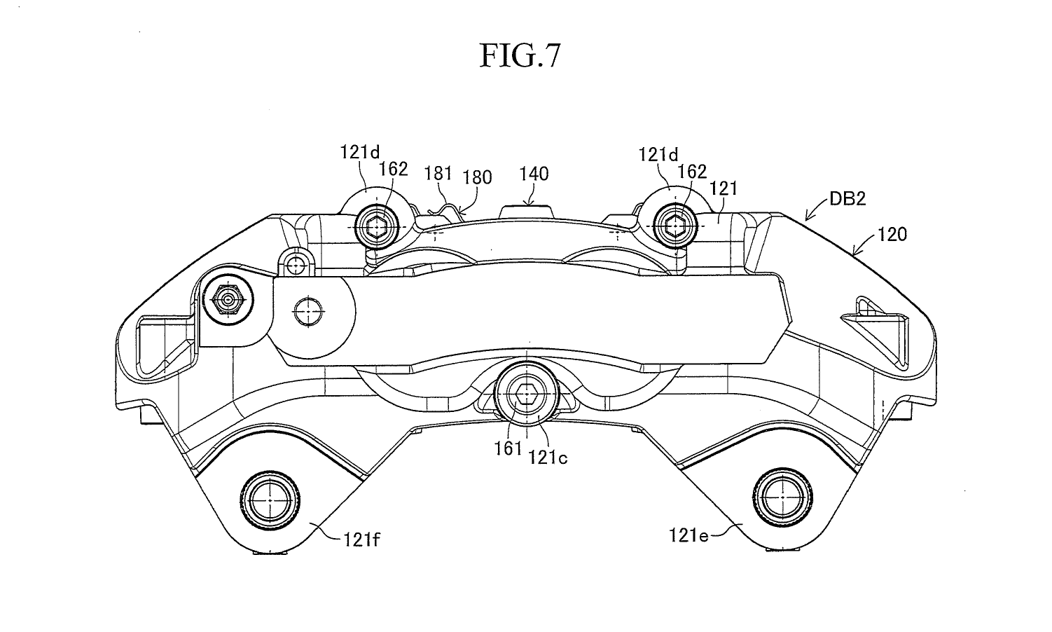

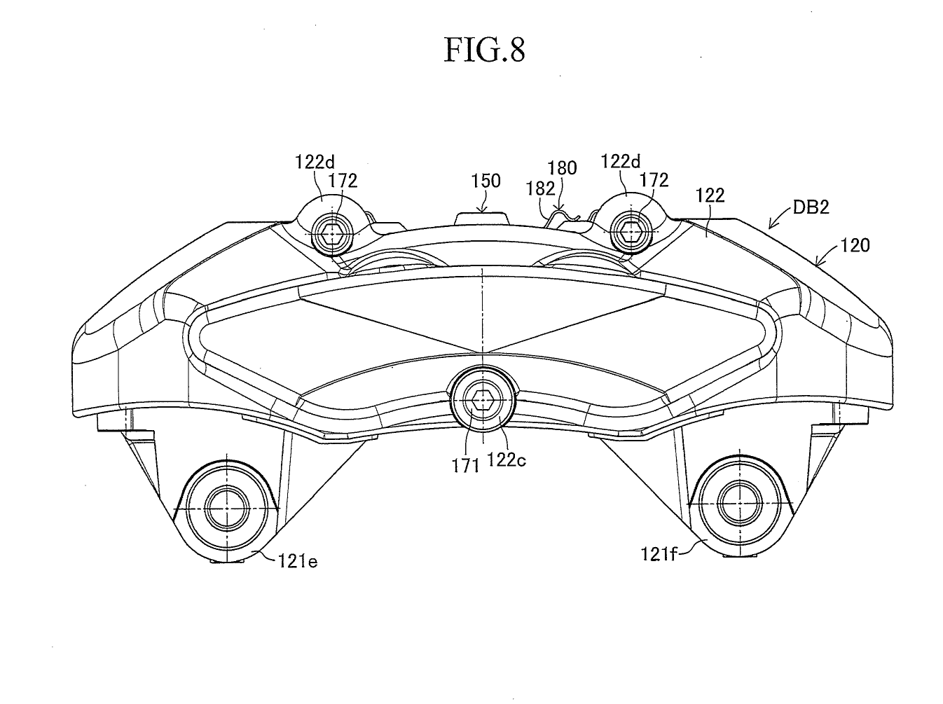

FIGS. 7 to 10 show a second embodiment in which a disc brake apparatus of the present invention is utilized as an opposed piston type (fixed type) disc brake apparatus for a vehicle. A disc brake apparatus DB2 according to the second embodiment is provided with a disc rotor 110 connected to an axle hub (a rotating member not shown in the figures) and rotated integrally with a wheel (not shown), a caliper 120 arranged so as to be astride a part of an outer peripheral portion of this disc rotor 110, four pistons 131, 132, 133, 134 connected to this caliper 120, an inner-side brake pad 140, and an outer-side brake pad 150. The disc brake apparatus DB2 is also provided with an inner-side inner periphery support shaft 161, a pair of inner-side outer periphery support shafts 162, 162, an outer-side inner periphery support shaft 171, a pair of outer-side outer periphery support shafts 172, 172, and a plate spring 180.

According to the second embodiment, a pair of the inner-side outer periphery support shafts 162, 162 arranged at a predetermined interval in the rotor circumferential direction across the center of the brake pads 140, 150 (linings 142, 152) in the rotor circumferential direction is adapted instead of the inner-side outer periphery support shaft 62 of the first embodiment described above. A pair of outer peripheral abutments 141b, 141b arranged at a predetermined interval in the rotor circumferential direction across the center of the brake pads 140, 150 in the rotor circumferential direction is also adapted instead of the outer peripheral abutment 41b of the first embodiment described above.

According to the second embodiment, a pair of the outer-side outer periphery support shafts 172, 172 arranged at a predetermined interval in the rotor circumferential direction across the center of the brake pads 140, 150 in the rotor circumferential direction is adapted instead of the outer-side outer periphery support shaft 72 of the first embodiment described above. A pair of outer peripheral abutments 151b, 151b arranged at a predetermined interval in the rotor circumferential direction across the center of the brake pads 140, 150 in the rotor circumferential direction is also adapted instead of the outer peripheral abutment 51b of the first embodiment described above.

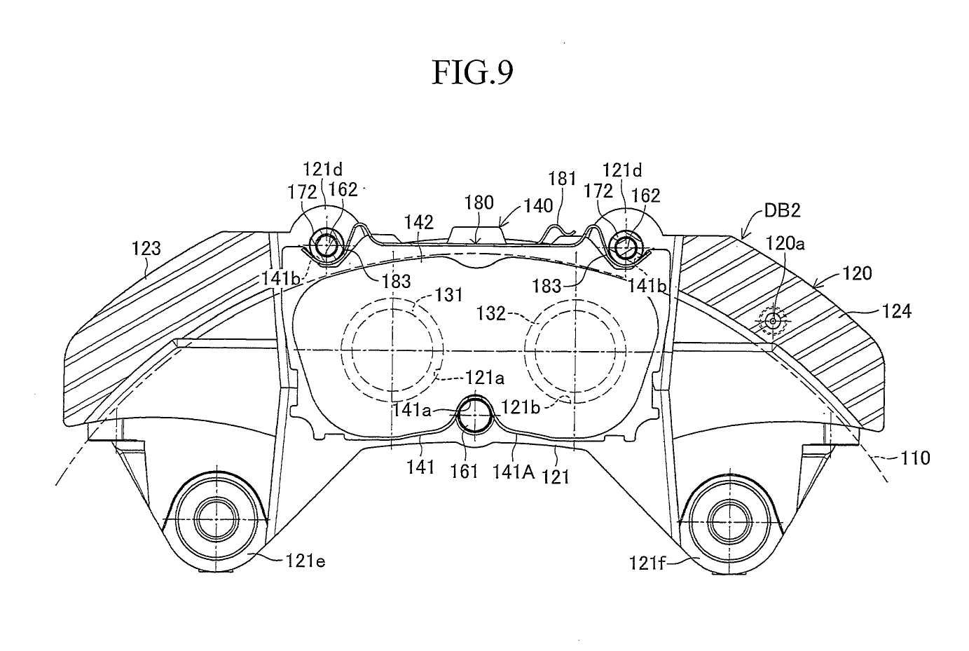

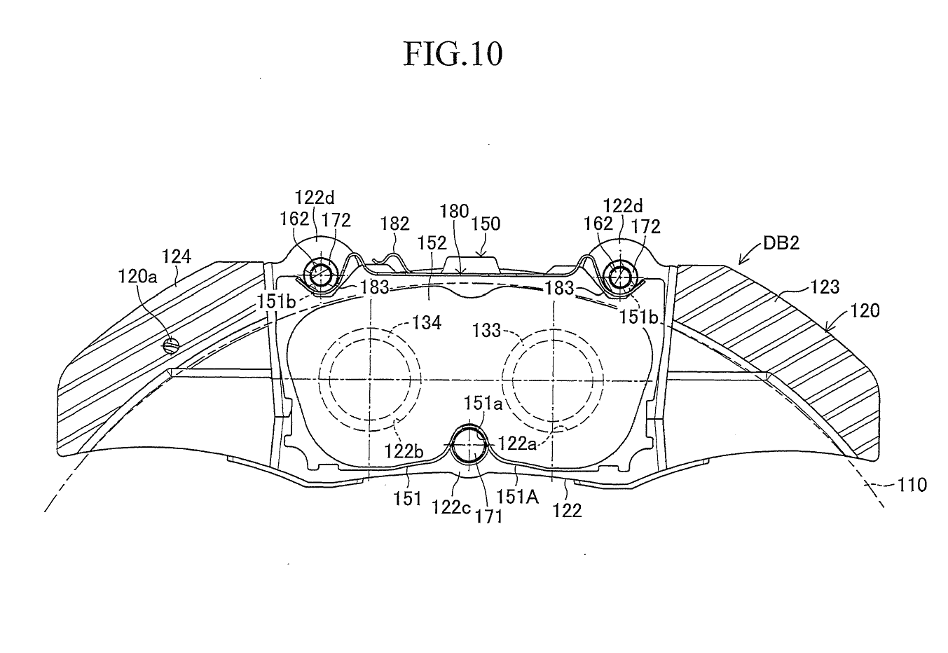

According to the second embodiment, an inner-side arm 181 is adapted instead of the leading-side arm 81a and the trailing-side arm 81b of the first embodiment described above, and an outer-side arm 182 is also adapted instead of the leading-side arm 82a and the trailing-side arm 82b of the first embodiment described above. It should be noted that according to the second embodiment, the outer peripheral abutment 141b on the left side shown in FIG. 9 is engaged with the inner-side outer periphery support shaft 162 on the left side without any gap inbetween, and the outer peripheral abutment 151b on the right side shown in FIG. 10 is engaged with the outer-side outer periphery support shaft 172 on the right side without any gap inbetween.

The other arrangement of the second embodiment is essentially the same as the other arrangement of the first embodiment described above. Thus, the reference numerals for parts in the second embodiment will be numbers 100 more than the reference numerals for the same parts in the first embodiment. Description of those parts will be omitted. The effect obtained according to the second embodiment is essentially the same as the effect obtained according to the first embodiment described above. Since the effect is supposed to be easily understood by one skilled in the art, description thereof will be omitted.

### Modification of First and Second Embodiments

According to the first and second embodiments described above, the plate spring (80, 180) biases the inner-side brake pad (40, 140) and the outer-side brake pad (50, 150) inward in the rotor radial direction so that the leading parts of the brake pads are on the outer side of the trailing parts of the brake pads in the rotor radial direction. However, the type of the bias member is not limited to the plate spring but the bias member may be properly modified to a rod spring, for example.

According to the embodiments described above, the inner-side outer periphery support shaft (62, 162) and the outer-side outer periphery support shaft (72, 172) are integrally coupled to each other by screwing. However, these shafts may be separately provided.

According to the embodiments described above, the caliper 20, 120 is provided with the inner housing portion 21, 121 and the outer housing portion 22, 122 facing each other across part of the outer peripheral portion of the disc rotor 10, 110, and also a pair of the coupling portions 23, 24, 123, 124 for coupling these housing portions, and all those are integrally formed. However, a caliper in which an inner housing portion and an outer housing portion are respectively divided into two in the rotor axial direction and these are coupled by a plurality of coupling bolts may be adapted.

According to the embodiments described above, two cylinders are respectively formed in the inner housing portion 21, 121 and the outer housing portion 22, 122 of the caliper 20, 120. However, one cylinder or three or more cylinders may be respectively provided in the inner housing portion and the outer housing portion of the caliper with one piston or three or more pistons to be connected to the cylinder(s).

What is claimed is:

1. A disc brake apparatus, comprising:
a disc rotor connected to a rotating member and rotated integrally with the rotating member;
a caliper connected to a support member so as to be astride a part of an outer periphery of the disc rotor;
a pair of brake pads arranged so as to grip the disc rotor and supported on the caliper movably in the rotor axial direction;
pistons connected to the caliper for pressing the brake pads toward the disc rotor, the pistons being adapted to press back plates of the brake pads so that linings of the brake pads are slidably forced against brake surfaces of the disc rotor for braking the disc rotor;
a bias member for biasing the brake pads inward in the rotor radial direction;
a single pair of inner periphery support shafts provided integrally with the caliper and respectively engaged at two points with V-shape inner peripheral abutments provided in the back plates on the inner side of the linings in the rotor radial direction and on the center in the rotor circumferential direction for supporting the brake pads; and
outer periphery support shafts provided integrally with the caliper and respectively engaged at one point with outer peripheral abutments provided in the back plates on the outer side of the linings in the rotor radial direction and on the middle in the rotor circumferential direction for supporting the brake pads.

2. The disc brake apparatus according to claim 1, wherein
a single pair of the outer periphery support shafts and a single pair of the outer peripheral abutments are respectively arranged on the center of the linings in the rotor circumferential direction.

3. The disc brake apparatus according to claim 1, wherein
two pairs of the outer periphery support shafts and two pairs of the outer peripheral abutments are respectively arranged at a predetermined interval in the rotor circumferential direction across the center of the linings in the rotor circumferential direction.

4. The disc brake apparatus according to claim 1, wherein
the bias member has the bias force set so that leading parts of the brake pads are on the outer side of trailing parts of the brake pads in the rotor radial direction.
